(19) United States
(12) Patent Application Publication
(10) Pub. No.: US 2021/0250226 A1
(43) Pub. Date: Aug. 12, 2021

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Takeyuki Nagashima, Tokyo (JP)

(21) Appl. No.: 17/166,943

(22) Filed: Feb. 3, 2021

(30) Foreign Application Priority Data
Feb. 10, 2020 (JP) 2020-020923

(51) Int. Cl. H04L 12/24; H04L 29/08

(52) U.S. Cl. CPC H04L 41/0654; H04L 67/28

(57) ABSTRACT

A proxy unit operates as a proxy server for a self-monitoring device so that operation information from the self-monitoring device is transmitted to the management server. A function monitoring unit receives the operation information for identifying a state of a self-monitoring function of the self-monitoring device when the proxy unit operates as a proxy server. Subsequently, the function monitoring unit determines whether or not the self-monitoring function has an abnormality based on the operation information.

### BACKGROUND OF THE INVENTION

### Field of the Invention

The present invention relates to an information processing apparatus, an information processing method, and a storage medium for quickly performing device maintenance, for example, error handling in a device and the replenishment of consumables.

### Description of the Related Art

A device management system that performs maintenance for a device installed in, for example, an office via a network has been conventionally known. The use of the device management system makes it possible, for example, to detect the occurrence of a failure in a device, the necessity of replenishing consumables, and the like via the network, and to quickly respond to them. For example, Japanese Patent Application Laid-Open No. 2018-136876 discloses a device management system.

Conventionally known device management systems include a system that includes a plurality of devices to be managed and a management server that receives operation information from the devices, and integrally manages the devices. The device management systems may further include an information processing apparatus that functions as a management client that receives data from a plurality of devices to be managed, generates operation information, and transmits the operation information to a management server. In this context, the operation information is information including status information, counter information, sensor information, and log information, which are information related to a failure in a device and consumables. The operation information is used by the management server for performing, for example, device management service and device maintenance service.

When a failure or the like occurs in a device, an operator needs to go to a place where the device is installed in order to perform a recovery operation, depending on, for example, the type of the failure. Hence, in order to reduce a time from the occurrence of the failure or the like to the recovery, that is, the downtime, a stable operation for the device management system is desired.

Here, the devices to be managed are broadly classified into devices compatible with a self-monitoring function (hereinafter, referred to as a “self-monitoring device”) and devices not compatible with the self-monitoring function (hereinafter, referred to as a “non-self-monitoring device”). The self-monitoring function is a function of collecting the operation information based on the control of the device itself, and transmitting the collected operation information to the management server. The non-self-monitoring device transmits the operation information in response to polling or the like from the management client.

In the device management system of Japanese Patent Laid-Open No. 2018-136876, the management client has a proxy function therein that relays communication of the operation information (hereinafter, simply referred to as a “proxy”). Additionally, settings for using the proxy of the management client are made for the devices to be managed as well. As a result, the operational information is transmitted from the devices to the management server via the proxy of the management client.

In conventional device management systems, no management client operating as a proxy analyzes the communication status and the contents of the operation information from each device to be managed. Accordingly, it is impossible for the management client to determine whether or not the self-monitoring function of the devices to be managed is operating normally. Hence, even if there is a self-monitoring device that cannot appropriately transmit the operation information due to the occurrence of an abnormality in the self-monitoring function for some reason, the management client cannot recognize such an abnormality. In the situation in which an abnormality occurs in the self-monitoring function of the self-monitoring device, a notification about failures such as a component failure occurring in the self-monitoring device itself may fail to be provided to the management server. In such a case, it is impossible to realize quick maintenance for the self-monitoring device.

### SUMMARY OF THE INVENTION

The present invention has been made in order to solve the above problem and provides a mechanism for recognizing the occurrence of an abnormality in a self-monitoring function of a device in an information processing apparatus that is a management client operating as a proxy.

An information processing apparatus transmits operation information acquired by executing a request to a network device based on monitoring settings to a management server via a network, wherein, according to one embodiment of the present invention, the information processing apparatus comprises: a memory storing instructions; and a processor executing the instructions causing the information processing apparatus to: enable an operation as a proxy server for the network device so that the operation information from the network device is transmitted to the management server without the request; receive information for identifying a state of a function of handling operation information of the network device itself being executed on the network device during operation as the proxy server for the network device; and determine whether or not the function has an abnormality based on the information for identifying the state of the function.

Further features of the present invention will become apparent from the following description of exemplary artifacts (with reference to the attached drawings).

### BRIEF DESCRIPTION OF THE DRAWINGS

FIG. 1 is a conceptual diagram schematically illustrating a network configuration of a device management system including an information processing apparatus according to each embodiment of the present invention.

FIG. 2 is a block diagram schematically illustrating a hardware configuration of a management server and a management client according to each embodiment of the present invention.

FIG. 3 is a block diagram schematically illustrating a hardware configuration of a device according to each embodiment of the present invention.

FIG. 4 is a block diagram schematically illustrating a software configuration of a device management system according to the first embodiment of the present invention.

FIG. 5 is a schematic flowchart of device application control executed by the management client to realize the self-monitoring function according to the first embodiment of the present invention.

FIG. 6 is a block diagram schematically illustrating a software configuration of a self-monitoring device according to the second embodiment of the present invention.

FIG. 7 is a schematic flowchart of device application control executed by the management client to realize the self-monitoring function according to the second embodiment of the present invention.

FIG. 8 is a schematic flowchart of the device application control executed by the management client to realize the self-monitoring function according to the third embodiment of the present invention.

### DESCRIPTION OF THE EMBODIMENTS

### First Embodiment

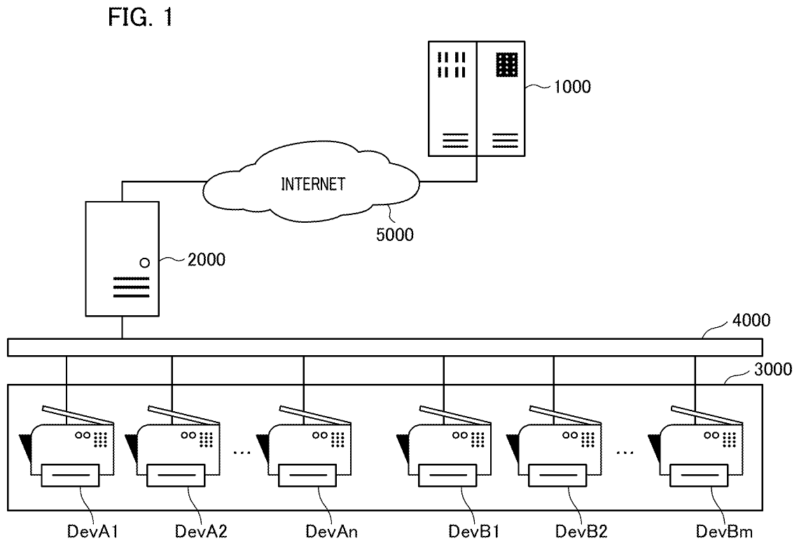

Hereinafter, a device management system according to the first embodiment of the present invention will be described below with reference to FIG. 1 to FIG. 5. FIG. 1 is a conceptual diagram illustrating a network configuration of the device management system according to the present embodiment. The device management system of the present embodiment includes a management server 1000, a management client 2000, and a device group 3000.

The management server 1000 is connected to the management client 2000, for example, via the Internet 5000. As described below, the management server 1000 integrally manages the management client 2000 and each of devices DevA1 to DevAn and DevB1 to DevBm (“n” and “m” are natural numbers) of the device group 3000. Various types of data received from the management client 2000 are used for this management. The management server 1000 may include a single computer or a plurality of computers. Further, a computer using cloud computing technology may be used as the management server 1000.

The management client 2000 is connected to the devices DevA1 to DevAn and DevB1 to DevBm of the device group 3000 via a network, for example, an intranet 4000. As the intranet 4000, for example, a LAN (Local Area Network) or the like can be adopted. Subsequently, in accordance with monitoring settings, the management client 2000 requests the devices DevA1 to DevAn and DevB1 to DevBm to provide operation information, that is, information about the occurrence of a failure or replenishment of consumables of each device, and acquires the information. The management client 2000 transmits the acquired operation information to the management server 1000.

The device group 3000 includes devices compatible with the self-monitoring function, that is, the self-monitoring devices DevA1 to DevAn, and devices not compatible with the self-monitoring function, that is, the non-self-monitoring devices DevB1 to DevBm.

Although FIG. 1 illustrates a configuration in which the management server 1000 and the management client 2000 are connected via the Internet 5000, the management server 1000 and the management client 2000 may be connected via another network, for example, the intranet 4000.

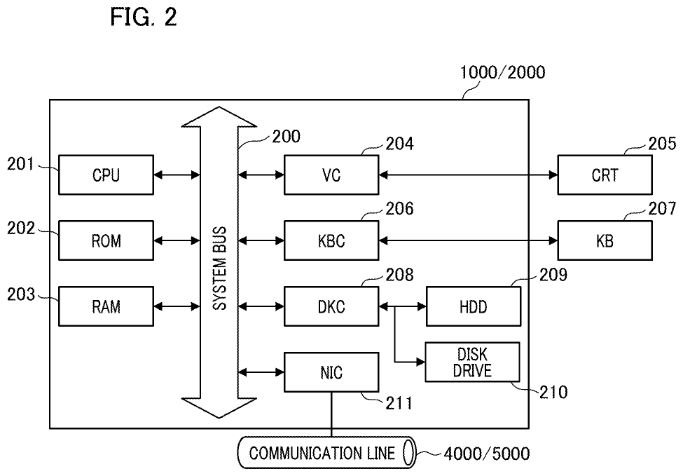

FIG. 2 is a block diagram schematically illustrating a hardware configuration of the management server 1000 and the management client 2000. That is, the management server 1000 and the management client 2000 have substantially the same hardware configuration. Hereinafter, a description will be given for an example of the hardware configuration of the management client 2000.

In FIG. 2, a CPU 201 reads out and executes software stored in, for example, a ROM (Read Only Memory) 202 and an HDD (Hard Disk Drive) 209. When executing the software, the CPU 201 uses a RAM (random access memory) 203 as a work area.

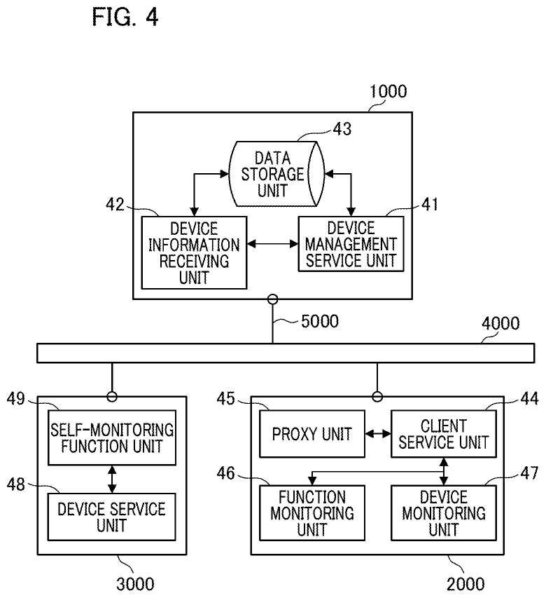

Accordingly, the CPU 201 configures a client service unit 44, a proxy unit 45, a function monitoring unit 46, and a device monitoring unit 47 (refer to FIG. 4), which will be described below, by software and operates them. Additionally, the CPU 201 accesses other hardware elements 204 to 211 through the system bus 200, and executes the control to be described below.

The video card (VC) 204 operates a display device (CRT) 205 based on the control of the CPU 201. The display device 205 operates as a user interface for a system administrator or the like to, for example, operate the management client 2000 based on the control of the CPU 201.

The keyboard controller (KBC) 206 performs a process of receiving operation inputs from a keyboard (KB) 207 and a pointing device (for example, a mouse) based on the control of the CPU 201.

The disk controller (DKC) 208 causes the HDD 209 and a disk drive 210 to execute, for example, a software reading operation and a data writing operation based on the control of the CPU 201.

The HDD 209 stores software, data, and the like. As described above, this software includes software for causing the CPU 201 to form the client service unit 44, the proxy unit 45, the function monitoring unit 46, and the device monitoring unit 47.

The disk drive 210 can mount storage media such as a floppy disk, a CD-ROM, a DVD, and an IC memory card. The disk drive 210 performs a writing operation and a reading operation on the mounted storage medium.

The network interface board (NIC) 211 communicates with the management server 1000 via the Internet 5000 based on the control of the CPU 201. Additionally, the network interface board 211 communicates with the devices DevA1 to DevAn and DevB1 to DevBm of the device group 3000 via the intranet 4000.

As described above, the management server 1000 has a hardware configuration similar to the management client 2000. However, the CPU 201 of the management server 1000 configures a device management service unit 41, a device information receiving unit 42, and a data storage unit 43 (refer to FIG. 4), which will be described below, by software and operates them.

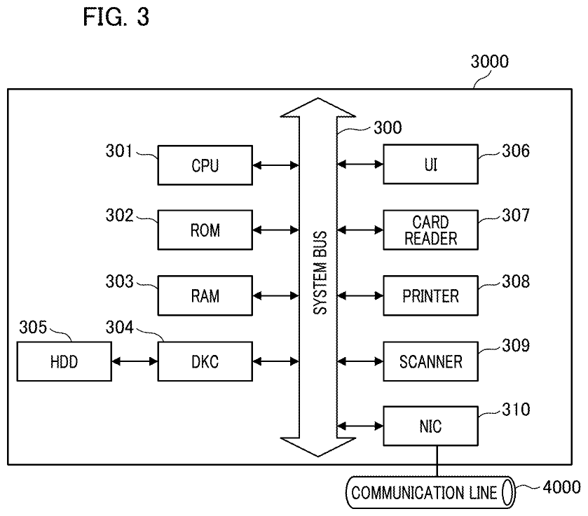

FIG. 3 is a block diagram schematically illustrating a hardware configuration of the devices DevA1 to DevAn and DevB1 to DevBm configuring the device group 3000. The devices DevA1 to DevAn and DevB1 to DevBm are image forming apparatuses such as a printer, a copying machine, a digital multifunction device, and a three-dimensional printer.

The devices DevA1 to DevAn and DevB1 to DevBm have functions related to printing such as printing and copying, and functions of connecting to the intranet 4000 and communicating with external devices such as the management client 2000.

A CPU 301 functions as a controller that controls the entire system. For this purpose, the CPU 301 reads the control program from a ROM 302 or an HDD 305. When the control program is read from the HDD 305, the reading is controlled by a disk controller (DKC) 304.

A RAM 303 is used as a work area when the CPU 301 executes a control program. When the CPU 301 executes the control program, a device service unit 48 and a self-monitoring function unit 49 (refer to FIG. 4) can be configured by software and operated.

A UI 306 is a user interface for allowing a user to use a printer 308 and a scanner 309, and includes a switch and an LED indicator for the user to operate. Information indicating an operation that has been performed by the user using the UI 306 is transmitted to the CPU 301.

A card reader 307 reads the user information from the IC card at the time of login processing and transmits it to the CPU 301. The CPU 301 collates this user information with the user information stored in the HDD 307 in advance to execute user authentication.

The printer 308 executes printing processing based on the control of the CPU 301. Similarly, the scanner 309 executes document reading processing based on the control of the CPU 301. Specifically, the control processing for the printer 308 and the scanner 309 is performed by the device service unit 48 configured by software by the CPU 301.

A network interface card (NIC) 310 communicates with a management client 2000 via the intranet 4000.

FIG. 4 is a block diagram conceptually illustrating an example of the software configuration of the management server 1000, the management client 2000, and the device group 3000. With respect to the devices DevA1 to DevAn and DevB1 to DevBm included in the device group 3000, only one self-monitoring device is shown in FIG. 4. As shown in FIG. 4, the management server 1000 includes the device management service unit 41, the device information receiving unit 42, and the data storage unit 43.

The device management service unit 41 manages the devices DevA1 to DevAn and DevB1 to DevBm. For example, the device management service unit 41 can detect the occurrence of a failure in the devices DevA1 to DevAn and DevB1 to DevBm, and the necessity of replenishing consumables via the intranet 4000. As the device management service unit 41, what is referred to as a “cloud service” can be used.

The device information receiving unit 42 receives the management information of the devices DevA1 to DevAn and DevB1 to DevBm, and transmits the management information to the device management service unit 41. The data storage unit 43 is a storage region that stores the management information of the devices DevA1 to DevAn and DevB1 to DevBm, and, for example, a part of the storage region provided in the HDD 209 is used.

The management client 2000 includes the client service unit 44, the proxy unit 45, the function monitoring unit 46, and the device monitoring unit 47. By this configuration, the management client 2000 operates as a proxy server. The proxy unit 45 relays the transmission of the operation information from the devices DevA1 to DevAn, which have the self-monitoring function, to the management server 1000. Note that the setting corresponding to the proxy information set in the proxy unit 45 of the management client 2000 is performed in advance for the devices DevA1 to DevAn and DevB1 to DevBm.

The client service unit 44 acquires the device information of the devices DevA1 to DevAn and DevB1 to DevBm from the data storage unit 43 of the management server 1000. Subsequently, the client service unit 44 controls the function monitoring unit 46 and the device monitoring unit 47 based on the device information to monitor the devices DevA1 to DevAn and DevB1 to DevBm. Details of the operations of the client service unit 44, the function monitoring unit 46, and the device monitoring unit 47 will be described below.

In addition to the proxy function of the management client 2000, another proxy server may be provided in a communication path between the management server 1000 and the devices DevA1 to DevAn and DevB1 to DevBm.

The self-monitoring devices DevA1 to DevAn of the device group 3000 are provided with the device service unit 48 and the self-monitoring function unit 49. As described above, the device service unit 48 performs control processing of the printer 308 and the scanner 309.

The self-monitoring function unit 49 monitors by itself whether or not failures such as an errors have been generated in the self-monitoring devices DevA1 to DevAn. When determining that failures such as an error have occurred, the self-monitoring function unit 49 collects the operation information related to the failures. The collected operation information is transmitted from the device service unit 48 to the device information receiving unit 42 of the management server 1000 through the proxy unit 45 of the management client 2000, and is transferred from the device information receiving unit 42 and stored in the data storage unit 43. Specifically, when the management client 2000 receives the operation information from the self-monitoring devices DevA1 to DevAn, the management client 2000 transfers this operation information to the management server 1000 by using the proxy unit 45. In this transfer, the client service unit 44 is not involved.

Note that the self-monitoring function unit 49 is one what are referred to as “device applications” that operate on the devices DevA1 to DevAn. Therefore, the self-monitoring function unit 49 has functions such as starting, stopping, updating, and deleting, as characteristics of the device application.

In contrast, the non-self-monitoring devices DevB1 to DevBm have only the device service unit 48, and do not have the self-monitoring function unit 49. For this reason, with respect to the non-self-monitoring devices DevB1 to DevBm, the device monitoring unit 47 of the management client 2000 accesses the device service unit 48 by using what is referred to as “polling” or the like to monitor whether or not failures such as an error have occurred in a timely manner.

When it is determined that failures such as an error have occurred, the device monitoring unit 47 of the management client 2000 collects the operation information related to the failure from the device service unit 48 of the non-self-monitoring devices DevB1 to DevBm. Subsequently, the device monitoring unit 47 transfers the collected operation information to the device information receiving unit 42 of the management server 1000 through the client service unit 44, the device information receiving unit 42 transfers the information to the data storing unit 43, and the information is stored in the data storing unit 43. Specifically, when receiving the operation information from the non-self-monitoring devices DevB1 to DevBm, the management client 2000 transfers this operation information to the management server 1000 by using the device monitoring unit 47 and the client service unit 44. In this transfer, the proxy unit 45 is not involved.

As described above, in the self-monitoring devices DevA1 to DevAn, the self-monitoring function unit 49 monitors the state of the device by itself, and when there is a failure, the self-monitoring function unit 49 transmits the operation information to the management server 1000 through the management client 2000. Therefore, when the self-monitoring function unit 49 itself stops for some reason and the operation information cannot be transmitted, the notification about the failure is not provided to the management server 1000.

The operation information transmitted by the self-monitoring function unit 49 may significantly affect the downtime of the self-monitoring devices DevA1 to DevAn, for example, support by a service person is required depending on the error content. Hence, it can be said that the self-monitoring function unit 49 has a particularly high need for a stable operation in comparison to the other device applications.

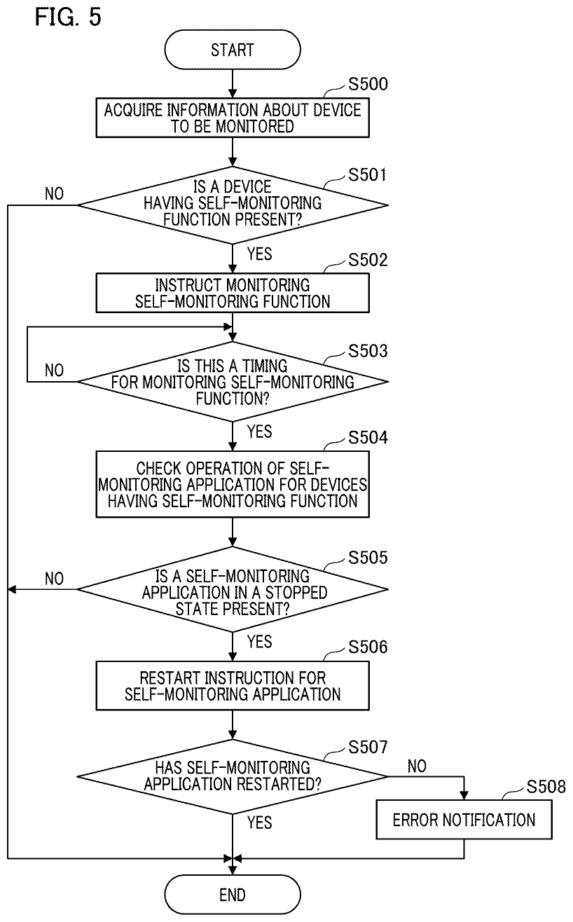

Accordingly, in the present embodiment, the management client 2000 is provided with the function monitoring unit 46 to monitor the self-monitoring function unit 49. Hereinafter, the operation of the function monitoring unit 46 will be described in detail with reference to the flowchart of FIG. 5.

First, the client service unit 44 of the management client 2000 accesses the data storage unit 43 via the device information receiving unit 42 of the management server 1000. This access is performed by the client service unit 44 periodically performing a request to the data storage unit 43. Subsequently, the client service unit 44 acquires, from the data storage unit 43, the information about the devices to be managed, in other words, the device information of the devices DevA1 to DevAn and DevB1 to DevBm belonging to the device group 3000 (step S500).

In this context, the device information is information for specifying device attributes such as a device name, a device IP address, and the presence or absence of the self-monitoring function. The device information is information for identifying a state of a function of handling the operation information of each device. Additionally, the presence or absence of the self-monitoring function may be set in advance when the device is registered in the data storage unit 43, or may be set by the client service unit 44 of the management client 2000 performing device search. For the device search, known search techniques such as SNMP, IP Broadcast, and SLP/Multicast can be used.

Next, the client service unit 44 determines whether or not the self-monitoring device is present in the device group 3000 by using the device information that has been acquired in step S500 (step S501). If it is determined that the self-monitoring device is “not present”, the process of FIG. 5 ends.

In contrast, if it is determined in step S501 that “the self-monitoring device is present in the device group 3000.”, the client service unit 44 provides an instruction to the function monitoring unit 46 to monitor the self-monitoring device (step S502). In the present embodiment, the client service unit 44 provides an instruction to the function monitoring unit 46 to monitor the self-monitoring devices DevA1 to DevAn.

In the present embodiment, the function monitoring unit 46 executes monitoring processing of the self-monitoring devices DevA1 to DevAn at each predetermined monitoring timing. For this purpose, the function monitoring unit 46 first waits until the time reaches the monitoring timing (step S503). When the time reaches the monitoring timing, the process proceeds to step S504.

Here, the monitoring timing may be a predetermined time, a time after the lapse of a predetermined time from the previous monitoring processing, or the monitoring timing may be determined by using other criteria. The same monitoring timing may be provided for all the self-monitoring devices DevA1 to DevAn, or different monitoring timings may be provided for each of them.

When the time reaches the monitoring timing, the function monitoring unit 46 accesses, for example, each of the device service units 48 of the self-monitoring devices DevA1 to DevAn. Subsequently, the function monitoring unit 46 confirms whether or not a device application configuring the self-monitoring function unit 49 by software (hereinafter, referred to as a “self-monitoring application”) is operating (step S504).

Additionally, the function monitoring unit 46 determines whether a self-monitoring device in which the self-monitoring application of the self-monitoring function unit 49 is in a stopped state is “present” or “not present” among the self-monitoring devices DevA1 to DevAn (step S505). When the function monitoring unit 46 determines that a self-monitoring device in which the self-monitoring application of the self-monitoring function unit 49 is in a stopped state is “not present”, the process of FIG. 5 ends.

In contrast, when the function monitoring unit 46 determines that “a self-monitoring device in which the self-monitoring application of the self-monitoring function unit 49 is in a stopped state is present”, the function monitoring unit 46 provides an instruction to the device service unit 48 of the self-monitoring device to restart the self-monitoring application (step S506). At the same time, the function monitoring unit 46 transmits a notification indicating that the self-monitoring device is in a stopped state to the management server 1000, and causes the data storage unit 43 to store the notification.

Subsequently, the function monitoring unit 46 determines whether or not the restart of the self-monitoring application determined to be in a stopped state in step S506 has been completed (step S507). When the restart has been completed, the process of FIG. 5 ends.

In contrast, if the restart has not been completed after the lapse of the predetermined time, the function monitoring unit 46 transmits an error notification to the management client 2000 (step S508). When receiving the error notification, the client service unit 44 of the management client 2000 causes the display device (CRT) 205 to display an error.

Although, in the present embodiment, the error notification is transmitted to the client service unit 44 of the management client 2000, it may be transmitted to the device management service unit 41 of the management server 1000 or may be transmitted to another destination.

As described above, in the present embodiment, the function monitoring unit 46 periodically determines whether or not a self-monitoring application that has stopped is present (refer to step S505). In contrast, each of the self-monitoring function units 49 of the self-monitoring devices DevA1 to DevAn may periodically transmit a notification indicating that the device is in a normal operation state (that is, a heartbeat) to the function monitoring unit 46 of the management client 2000. This heartbeat may be transmitted, for example, to the device information receiving unit 42 of the management server 1000 through the proxy unit 45 of the management client 2000.

By the above process, in the present embodiment, even if the self-monitoring function unit 49 of the devices DevA1 to DevAn stops for some reason, it is possible to quickly restore it to a normal state. As a result, according to the present embodiment, it is possible to enhance the reliability of the management for the operation states of the self-monitoring devices DevA1 to DevAn.

### Second Embodiment

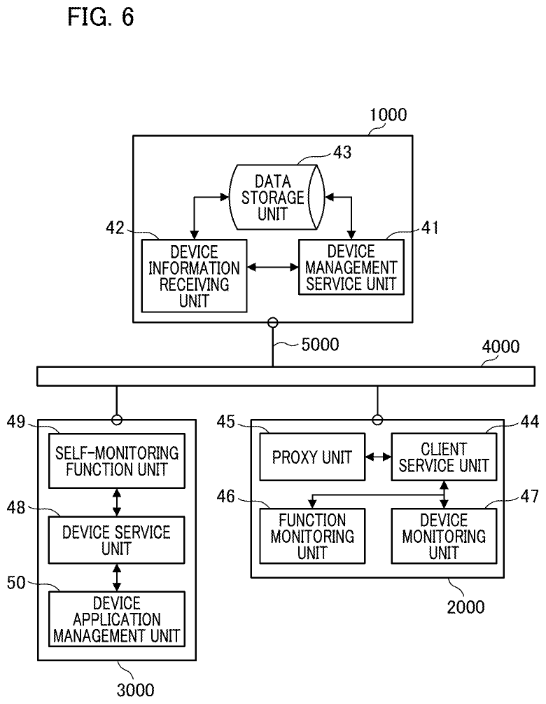

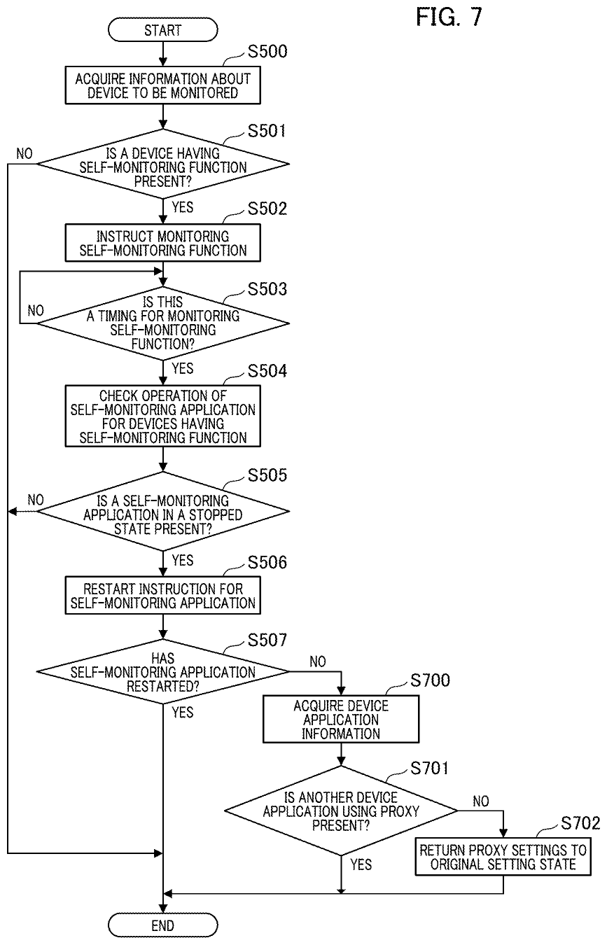

Next, a device management system according to the second embodiment of the present invention will be described with reference to FIG. 6 and FIG. 7. The network configuration, the hardware configuration, and the software configuration of the management server 1000, the management client 2000, and the devices DevA1 to DevAn and DevB1 to DevBm according to the present embodiment are substantially the same as those of the first embodiment (refer to FIG. 1 to FIG. 4). However, the present embodiment differs on the following points.

FIG. 6 is a block diagram conceptually illustrating a software configuration example of the self-monitoring devices DevA1 to DevAn. In FIG. 6, components to which the reference numerals that are the same as those in FIG. 4 are given are the components that are the same as those in FIG. 4.

The self-monitoring devices DevA1 to DevAn of the present embodiment have a device application management unit 50 for managing information as to whether or not each installed device application uses proxy information.

Additionally, in the present embodiment, the function monitoring unit 46 of the management client 2000 stores a revision log of the proxy setting for each of the self-monitoring devices DevA1 to DevAn. Specifically, also in the present embodiment, the proxy setting of the self-monitoring devices DevA1 to DevAn is changed in response to the change of the proxy setting of the management client 2000, as in the case of the first embodiment. However, the proxy setting before the change is stored in the function monitoring unit 46.

Hereinafter, a process of monitoring the self-monitoring function unit 49 of the self-monitoring devices DevA1 to DevAn in the present embodiment will be described. As described in the first embodiment, there are cases in which the self-monitoring devices DevA1 to DevAn fail to restart the self-monitoring application (refer to step S507).

If the restart of the self-monitoring application has failed, it is desirable to return the proxy setting of the self-monitoring function unit 49 to the state that is before the proxy setting has changed in accordance with the proxy setting of the management client 2000. Typically, the self-monitoring device has only one proxy setting, so that if a failure occurs in the proxy unit 45 of the management client 2000, the influence may affect the communication of the other device applications in the self-monitoring device. Hence, if the self-monitoring function unit 49 is not operating normally, it is desirable to return the setting so that the self-monitoring application does not use the proxy.

However, when a device application other than the self-monitoring application uses the information about the proxy setting, it is desirable that such a device application can use the proxy as it is. Hence, for example, it is desirable to continue using the proxy without returning the proxy setting to the previous state.

FIG. 7 is a flowchart illustrating monitoring processing of the self-monitoring function unit 49 in the present embodiment. In FIG. 7, the processes of steps S500 to S507 are the same as the processes having the same reference numerals in FIG. 5. As described below, the processes of the present embodiment is different from the processes of the above first embodiment in that the processes of steps S700 to S702 are performed instead of the error notification (refer to step 508 of FIG. 5) of the first embodiment or in addition to the error notification.

First, as in the first embodiment, the client service unit 44 of the management client 2000 acquires the device information from the data storage unit 43 of the management server 1000 (refer to step S500). Subsequently, as in the first embodiment, the restart of the self-monitoring application that is in a stopped state is executed (refer to steps S501 to S506).

Subsequently, the function monitoring unit 46 determines whether or not the restart of the self-monitoring application has been completed (step S507), and when the restart has been completed, the processing of FIG. 7 ends. In contrast, if the restart has not been completed after the lapse of the predetermined time, the function monitoring unit 46 performs the processing below.

If the function monitoring unit 46 determines that the restart has failed (step S507), the function monitoring unit 46 acquires the device application information including the presence or absence of the use of the proxy information from the corresponding device application management unit 50 (step S700).

Subsequently, the function monitoring unit 46 determines whether a device application other than the self-monitoring application that uses the proxy information is “present” or “not present” based on the device application information that has been acquired in step S700 (step S701).

If the function monitoring unit 46 determines that a device application other than the self-monitoring application that uses the proxy information is “not present” in step S701, the function monitoring unit 46 transmits an instruction for returning the proxy of each device to the original setting state to the devices DevA1 to DevAn (step S702). The original setting state is a setting state when the proxy unit 45 is not used. At this time, if the proxy information has not been set before the setting change, the proxy information of each device returns to an empty state. The function monitoring unit 46 may transmit an instruction to explicitly set the proxy setting of each device to an empty setting. After step S702, the function monitoring unit 46 ends the process of FIG. 7.

In contrast, if it is determined in step S701 that a device application other than the self-monitoring application that uses the proxy information is present, the function monitoring unit 46 ends the processing of FIG. 7 without returning the proxy information to the original setting state.

Note that the device application may include a device application that performs proxy setting for another device application. Such a device application does not have to be included in “another device application that uses the proxy information”. Accordingly, in the present embodiment, when “another device application that uses the proxy information” other than such a device application is not present, the proxy information is returned to the original setting state. Additionally, an instruction to change the proxy setting shown in step S702 may be transmitted to a target device without providing an instruction to restart the self-monitoring application in step S506. When it is determined that an abnormality has occurred in the self-monitoring function or that the restart of the self-monitoring application has failed, the setting of the proxy server of the network device is changed to empty, and the device monitoring similar to the non-self-monitoring device is performed. In other words, the device monitoring unit 47 requests the devices to provide the operation information to acquire the information. Thus, duplicate transmission of the operation information when the self-monitoring application of the device shifted to the monitoring by the device monitoring unit 47 returns to normal can be prevented.

By the above process, according to the present embodiment, even if the self-monitoring function of the self-monitoring devices DevA1 to DevAn stops for some reason, the normal operation of other functions can be easily ensured.

### Third Embodiment

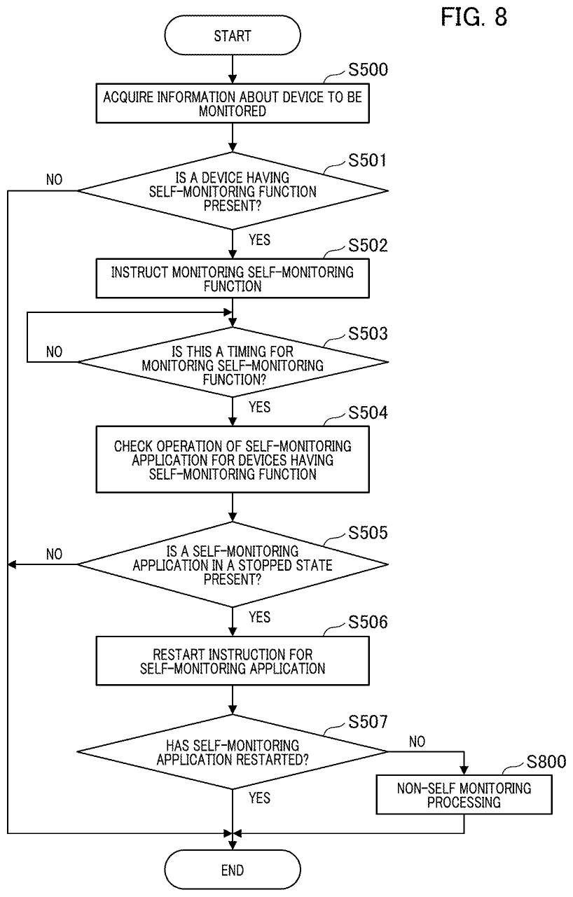

Next, a device management system according to the third embodiment of the present invention will be described with reference to FIG. 8. The network configuration, the hardware configuration, and the software configuration of the management server 1000, the management client 2000, and the devices DevA1 to DevAn and DevB1 to DevBm according to the present embodiment are substantially the same as those of the first embodiment (refer to FIG. 1 to FIG. 4). However, the present embodiment differs on the following points.

Hereinafter, a process of monitoring the self-monitoring function unit 49 of the self-monitoring devices DevA1 to DevAn in the present embodiment will be described. As described in the first embodiment, there are cases in which the self-monitoring devices DevA1 to DevAn fail to restart the self-monitoring application (refer to step S507).

If the restart has failed, operations such as self-monitoring application recovery processing is typically required in order to perform the operation of the self-monitoring application normally. The self-monitoring device cannot operate the self-monitoring function unit 49 normally until the self-monitoring application starts normally after the recovery processing. Hence, in the present embodiment, the self-monitoring device can be used as a non-self-monitoring device until the self-monitoring function unit 49 of the self-monitoring device returns to a normal operation.

FIG. 8 is a flowchart illustrating the monitoring processing of the self-monitoring function unit 49 in the present embodiment. In FIG. 8, the processes in steps S500 to S507 are the same as the processes in FIG. 5 to which the same reference numerals are provided. As described below, the processing of the present embodiment is different from the processing of the first embodiment in that the non-self-monitoring processing of step S800 is performed instead of the error notification of the first embodiment (refer to step S508 of FIG. 5) or in addition to this error notification.

First, as in the first embodiment, the client service unit 44 of the management client 2000 acquires the device information from the data storage unit 43 of the management server 1000 (refer to step S500). As in the first embodiment, the restart of the self-monitoring application that is in a stopped state is executed (refer to steps S501 to S506).

Subsequently, the function monitoring unit 46 determines whether or not the restart of the self-monitoring application has been completed (step S507), and when the restart has been completed, the process of FIG. 7 ends. In contrast, if the restart of the self-monitoring application has failed, the function monitoring unit 46 performs the non-self-monitoring processing to be described below (step S800).

In this non-self-monitoring processing, first, the function monitoring unit 46 of the management client 2000 requests the client service unit 44 to change the device from the self-monitoring device to the non-self-monitoring device.

Upon receipt of this request, the client service unit 44 provides an instruction to the device monitoring unit 47 to additionally register the device as a non-self-monitoring device.

After the additional registration, the device monitoring unit 47 of the management client 2000 monitors the device as a non-self-monitoring device. Specifically, the device monitoring unit 47 accesses the device service unit 48 by polling or the like, thereby the occurrence of a failure can be monitored.

By the above process, according to the present embodiment, even when the restart of the self-monitoring application has failed, the normal operation of other functions can be ensured.

### Fourth Embodiment

Next, a device management system according to the fourth embodiment of the present invention will be described. The network configuration, the hardware configuration, and the software configuration of the management server 1000, the management client 2000, and the devices DevA1 to DevAn and DevB1 to DevBm according to the present embodiment are substantially the same as those of the first embodiment (refer to FIG. 1 to FIG. 4). However, the present invention differs in the following points.

In the first embodiment, whether or not the self-monitoring application is operating is checked in order to determine whether the self-monitoring function unit 49 is normal or abnormal (refer to step S504 of FIG. 5). However, even if the self-monitoring application is operating, a failure that has occurred in the self-monitoring devices DevA1 to DevAn may not be detected or reported due to internal failures of the self-monitoring application. In such a case, even if various failures occur in the self-monitoring devices DevA1 to DevAn, the device management service unit 41 of the device management service unit 1000 cannot recognize the failures.

In contrast, in the present embodiment, the following process is performed instead of the process that is the same as in the first embodiment (refer to FIG. 5) or in addition to the process that is the same as in the first embodiment. As in the first embodiment, the device information receiving unit 42 of the management server 1000 stores transmission data such as device data and operation information of the self-monitoring devices DevA1 to DevAn.

The function monitoring unit 46 of the management client 2000 periodically accesses the data storage unit 43 through the client service unit 44 and the device information receiving unit 42 of the management server 1000. Subsequently, from the data storage unit 43, the function monitoring unit 46 acquires and stores the latest date and time information of the transmission data received from the self-monitoring devices DevA1 to DevAn. Subsequently, the function monitoring unit 46 determines whether or not the self-monitoring devices DevA1 to DevAn having no information updating within a predetermined time period is present based on the acquired latest date and time information.

Further, the function monitoring unit 46 provides an instruction to the device service unit 48 of the self-monitoring devices DevA1 to DevAn that have been determined not to have information updating within a predetermined time period to restart the self-monitoring application.

By the above processes, according to the present embodiment, when the self-monitoring devices DevA1 to DevAn cannot detect or report a failure even though the self-monitoring application is operating, the self-monitoring application can be restarted to return to a normal operation state. Note that the device management system may be configured to include all the features of the first to fourth embodiments.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-020923, filed Feb. 10, 2020, which is hereby incorporated by reference wherein in its entirety.

What is claimed is:

1. An information processing apparatus, which transmits operation information acquired by executing a request to a network device based on monitoring settings to a management server via a network, the information processing apparatus comprising:
a memory storing instructions; and
a processor executing the instructions causing the information processing apparatus to:
enable an operation as a proxy server for the network device so that the operation information from the network device is transmitted to the management server without the request;
receive information for identifying a state of a function of handling operation information of the network device itself being executed on the network device during operation as the proxy server for the network device; and
determine whether or not the function has an abnormality based on the information for identifying the state of the function.

2. The information processing apparatus according to claim 1,
wherein the instructions further cause the information processing apparatus to periodically perform a state request to the network device from the information processing apparatus so that information for identifying the state of the function is received.

3. The information processing apparatus according to claim 1,
wherein the instructions further cause the information processing apparatus to provide a notification to the management server if the function is determined to have an abnormality.

4. The information processing apparatus according to claim 1,
wherein the instructions further cause the information processing apparatus to provide an instruction to the network device to perform restart if the function is determined to have an abnormality.

5. The information processing apparatus according to claim 4,
wherein the instructions further cause the information processing apparatus to transmit an error notification to the management server via the network if the restart has not been performed normally.

6. The information processing apparatus according to claim 1,
wherein the instructions further cause the information processing apparatus to transmit an instruction for changing the settings of the proxy server of the network device referred to by the function of the network device to empty if the function is determined to have an abnormality.

7. The information processing apparatus according to claim 1,
wherein the instructions further cause the information processing apparatus to request the network device to provide operation information if the function is determined to have an abnormality and transmits the acquired operation information to the management server via the network.

8. The information processing apparatus according to claim 1,
wherein if a predetermined time period has elapsed since the latest date and time of data transmitted from the network device to the management server, the function is determined to have an abnormality.

9. A method for controlling an information processing apparatus, which transmits operation information acquired by executing a request to a network device based on monitoring settings to the management server via a network, the method comprising:
enabling an operation as a proxy server for the network device so that the operation information from the network device is transmitted to the management server without the request;
receiving information for identifying a state of a function of handling operation information of the network device itself being executed on the network device during operation as the proxy server for the network device; and
determining whether or not the function has an abnormality based on the information for identifying the state of the function.

10. A non-transitory storage medium on which is stored a computer program related to a method for controlling an information processing apparatus, which transmits operation information acquired by executing a request to a network device based on monitoring settings to a management server via a network, the method comprising:
enabling an operation as a proxy server for the network device so that the operation information from the network device is transmitted to the management server without the request;
receiving information for identifying a state of a function for handling operation information of the network device itself being executed on the network device during operation as the proxy server for the network device; and
determining whether or not the function has an abnormality based on the information for identifying the state of the function.
